(19) United States
(12) Patent Application Publication
(10) Pub. No.: US 2014/0324708 A1
(43) Pub. Date: Oct. 30, 2014

(54) RAW SENSOR INPUT ENCRYPTION FOR PASSCODE ENTRY SECURITY

(71) Applicant: Square, Inc., San Francisco, CA (US)

(72) Inventors: Nathan P. McCauley, San Francisco, CA (US); Oliver S.C. Quigley, San Francisco, CA (US); David C. Adams, San Francisco, CA (US); Troy J. Edwards, Los Gatos, CA (US); Lukas C. Skoog, San Francisco, CA (US); Jonathan D. Paull, San Francisco, CA (US)

(21) Appl. No.: 14/055,838

(22) Filed: Oct. 16, 2013

Related U.S. Application Data
(63) Continuation-in-part of application No. 13/800,789, filed on Mar. 13, 2013.
(60) Provisional application No. 61/859,253, filed on Jul. 28, 2013.
(60) Provisional application No. 61/658,828, filed on Jun. 12, 2012.

(51) Int. Cl. G06F 21/31; G06Q 20/40

(52) U.S. Cl. CPC G06F 21/31; G06Q 20/4012
USPC 705/72; 713/183

(57) ABSTRACT

A method of encrypting sensor input entries for passcode entry security is disclosed. The method in one embodiment includes presenting a passcode entry interface on an electronic device for a user to input a passcode entry. The electronic device then receives an input event, which is indicative of at least part of the passcode entry by the user, from a sensor of the electronic device. The electronic device then encrypts a sensor value of the input event and transmits the encrypted sensor value to an external system over a network to cause the external system to decipher the passcode entry from the encrypted sensor value.

### CROSS-REFERENCE TO RELATED APPLICATIONS

This application claims the benefit of U.S. Provisional Patent Application No. 61/859,253, filed Jul. 28, 2013 and is a continuation-in-part of U.S. patent application Ser. No. 13/800,789, filed on Mar. 13, 2013, which claims the benefit of U.S. Provisional Patent Application No. 61/658,828, filed on Jun. 12, 2012, where the entire contents of the above applications are all incorporated herein by reference in their entirety.

### BACKGROUND

Security in accessing and transmitting information is as crucial as security to protect physical possessions. Conventional security devices, such as number locks, may include devices that control access based on possession of a virtual “key,” such as in the form of private information (e.g., a passcode). A passcode is a combination of a sequence of characters, such as letters, numbers, special characters, or any combination thereof. In the digital realm, passcode-based locks are emulated by digital passcode-based security devices, such as by an automatic teller machine (ATM) key pad or a debit card personal identification number (PIN) key pad. These digital passcode-based security devices are generally specialized hardware devices (i.e., lacking a general purpose operating system/kernel to run different functional components) that control access to a system based on a user's knowledge of a passcode. Conventional digital passcode-based security devices are implemented on specialized devices because, among other reasons, any general-purpose device may enable installations of malware (i.e., software design for the purpose of overcoming security without authorization).

For example, in a conventional point-of-sale electronic payment card transaction, e.g., by a debit card or smart card such as a Europay, MasterCard, and Visa (EMV) card, a cardholder's identity and/or authenticity is confirmed by requiring an entry of a PIN rather than or in addition to signing a paper receipt. A user may enter a PIN on a specialized card reader. The card reader can then retrieve a PIN from the smart card. The PIN entered by a user can be compared against the retrieved PIN from the smart card. Authorization of the use of the card can be granted based on the entered PIN matching the retrieved PIN.

The example above uses a specialized device to authorize a user instead of a general-purpose device, which has an operating system enabling any third party application to run thereon. A general-purpose device enables ease of implementation of security sensitive applications. Ability to use general-purpose devices enables merchants and consumers, who wish to use or implement a secure authentication system, to use devices they already own for that purpose. However, making the card reader part of a general-purpose device may be unfeasible because of inability to defend adequately against malware's installation on the same general-purpose device. One particular form of malware that may be of concern in this context is malware that performs a static analysis of a payment authentication application on the general-purpose device; for example, such malware may have the ability to read the memory used by the payment authentication application. When the general-purpose device processes and stores a consumer's PIN, the general-purpose device may expose the PIN to discovery by malware of this type.

### BRIEF DESCRIPTION OF THE DRAWINGS

FIG. 1 is a data flow diagram illustrating a technique of sensor entry encryption.

FIG. 2 is a block diagram illustrating an electronic device for passcode entry.

FIG. 3 is a block diagram illustrating an authentication system for deciphering a passcode entry by a user.

FIG. 4 is a system architecture diagram of an electronic device illustrating a data path through which a sensor entry may be processed.

FIG. 5 illustrates a flow chart of a method of operating an electronic device to encrypt a sensor value indicative of a user input to a passcode entry interface.

FIG. 6 illustrates a flow chart of a method of operating a computing system for deciphering a passcode by a user.

FIG. 7 is a block diagram of a passcode entry system including an electronic device and an authentication system, configured.

FIG. 8 is a diagrammatic representation of a computer system.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

A technique to secure passcode entry on an electronic device is disclosed herein. The technique involves encrypting raw input events from an input device of an electronic device. A complete passcode entry may produce multiple raw input events, such as multiple touch events on a touch screen. In such instances, each raw input may represent the location of a touch event on a touch screen, and each event representing a touch location is encrypted. Thus, encryption of individual input events serves as a measure to prevent unauthorized discovery (e.g., by malware) of the passcode.

The disclosed technique can be advantageous, because no application memory of the electronic device contains the fully deciphered passcode; consequently, this technique prevents malware from discovering the passcode by static analysis of an application memory space on the electronic device. Furthermore, the input events indicative of the passcode can be encrypted at a kernel-level to prevent malware running on a user-application level of the operating system from logging the raw input events prior to encryption and to prevent any analysis to reverse-engineer the passcode based on a known passcode interface configuration.

In various embodiments, the encryption is based on public-key cryptography, requiring two separate keys, one of which is private/secret as held by the trusted computing system used for decryption and one of which is public as known to the electronic device used for encryption. Other encryption methods may be used instead of or in conjunction with the disclosed technique, including various symmetric and/or asymmetric encryption algorithms, such as the RSA encryption scheme with the Optimal Asymmetric Encryption Padding (RSAES-OAEP) standard or white box cryptography.

The raw input events can be touch events as recorded by a touch screen of the electronic device. A passcode interface, such as a PIN or key pad, may be displayed on the touch screen. The user may enter the passcode entry for authentication on the touch screen. The electronic device may encrypt the touch events resulting from the interaction with the touchscreen. The electronic device may then transmit the encrypted touch events represented by touch screen coordinates to a trusted computing system to cause the trusted computing system to decipher the passcode, as entered by the user, based on the encrypted touch events. “To cause” in this context is intended to include sending a command, a request, or any other type of message or signal that results in the stated action, such as deciphering the passcode based on the encrypted touch events.

In various embodiments, only the trusted computing system performs the transformation from the encrypted raw input events into the passcode entry. Instead of deciphering the passcode entry on the electronic device, the input events are sent to the trusted computing system for interpretation. The trusted computing system, which may be external to the electronic device, can then decrypt each input event to decipher the passcode entered by the user.

Deciphering of the passcode may include comparing the decrypted touch event to a passcode interface configuration. For example, the passcode interface configuration may be or include a key pad layout, which can be represented as a data structure or object. As a more specific example, the key pad layout can be generated by the trusted computing system and sent to the electronic device for presentation. As another specific example, the key pad layout can be generated by the electronic device, and sent to the trusted computing system for deciphering. Either way, the trusted computing system may use the passcode interface configuration, e.g., key pad layout, to map sensor input events to a sequence of characters used to compose the passcode entry.

The key pad layout may include geometry, position, relative position, animation sequence, or other variations of the presentation of the key pad. The key pad may include multiple buttons taking up regions of the touch screen of the electronic device. Each touch event may be represented by an (X,Y) location coordinate, where each coordinate or set of coordinates is encrypted in accordance with various embodiments of the disclosed technique. The passcode can then be deciphered by mapping each (X,Y) coordinate to a two dimensional space corresponding to a specific soft-button representing a character used to compose a passcode entry.

As another specific example, the raw input events can be touch events as recorded by a camera or an accelerometer of the electronic device. A malware application may potentially use other sensor inputs to derive the passcode entry through the passcode interface. Accordingly, the electronic device may encrypt the raw input events of various other sensors of the electronic device as well, to provide an extra security layer in preventing reverse engineering of the passcode.

In the above examples, both the presentation device of the passcode interface and the input device are exemplified as a touch screen. However, an audio-based passcode interface is contemplated as well. For example, the sensor input event may be vocalized syllables, words, phrases (“sound bites”) as recorded by a microphone. The passcode interface configuration may include the valid vocalized sound bites that may combined in sequence into a passcode entry.

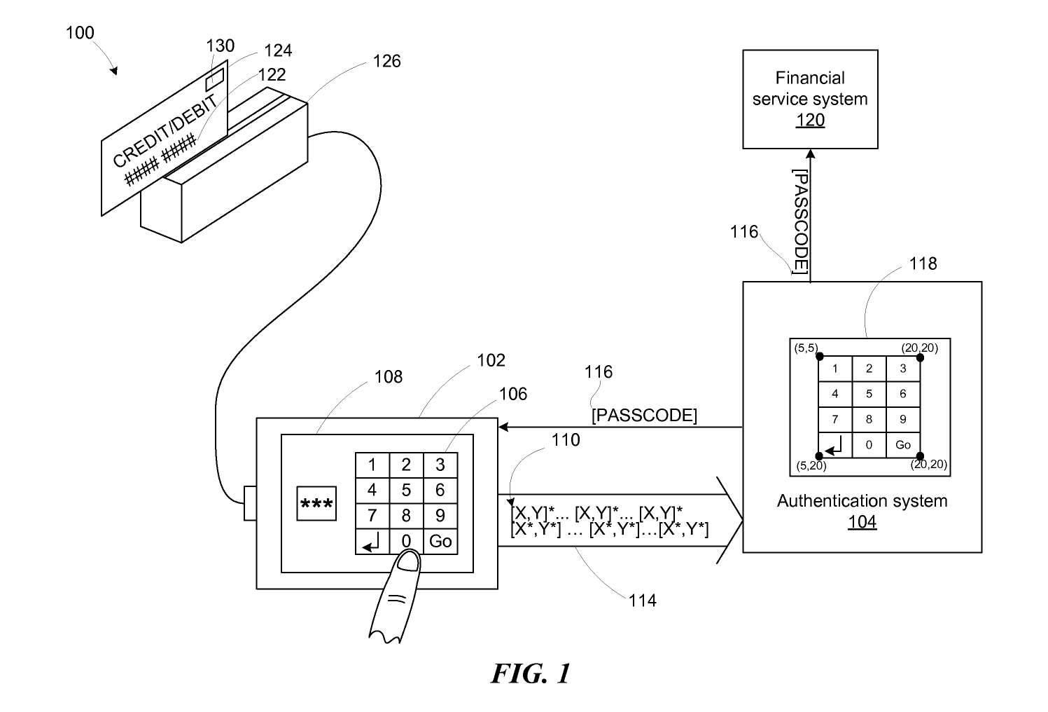

FIG. 1 is a data flow diagram illustrating a technique 100 of sensor entry encryption. As shown, the technique 100 involves an electronic device 102 and an authentication system 104. The electronic device 102 may be a general purpose device with data processing capabilities. For example, the electronic device 102 may be a mobile phone, a tablet, an e-reader, other mobile or portable computing devices, or other stationary computing devices. The authentication system 104 may be a trusted computing system in data communications with the electronic device 102, such as over a network. The authentication system 104 may be one or more computing devices. For example, the authentication system 104 may be a server computer, a network of computing systems, a cloud computing environment, a virtualized computing environment, or any combination thereof. Communication between the authentication system 104 and the electronic device 102 may be any form of data communication, including mobile telecommunication (e.g., cellular), WiFi, wireless Ethernet, wired Ethernet, or any other form of Internet connection.

The electronic device 102 may be a mobile device, such as a smartphone or a tablet computer, that presents a passcode interface 106 on an output device. In the illustrated embodiment, the output device is a touch screen 108. A user seeking authentication may input through a sensor (i.e. an input device) of the electronic device 102, a series of inputs composing a passcode, such as a PIN, a passphrase, a digital key, or any combination thereof. In the illustrated embodiment, the sensor is the touch screen 108. Note, however, that the sensor (e.g., a touch panel or a cursor device) for detecting an input may be different from the output device (e.g., a display, a projection device, a speaker, or other devices capable of presenting the passcode interface 106).

The sensor entries 110 together form a sensor input stream 114, such as a touch event stream. The sensor input stream 114 is a sequence of sensor entries. The sensor input stream 114 may be associated with a single user, a single session, a single application, or any combination thereof. When the passcode interface 106 is presented on the touch screen 108 and the user enters input at the passcode interface 106, the electronic device 102 captures and interprets the sensor input stream 114.

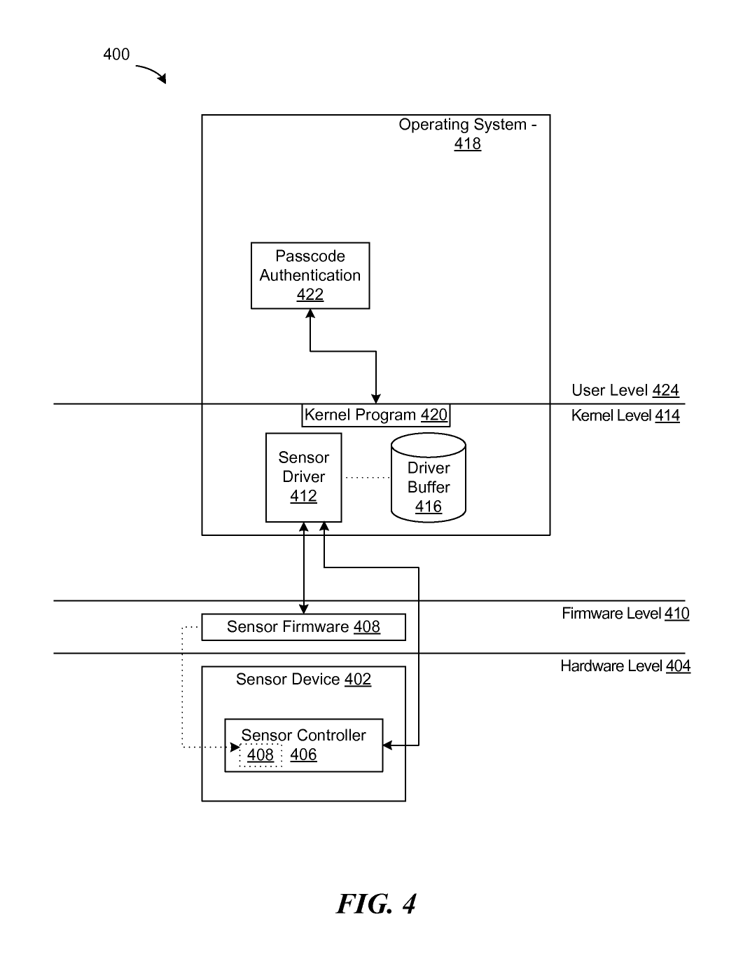

As each sensor entry 110 is captured by the sensor, the sensor entry 110 is routed to an operating system of the electronic device 102 for processing. The sensor entries 110 may be encrypted at any level along this data route. The data route propagates through a software stack of the electronic device 102 as illustrated in FIG. 4. The encryption may be based on asymmetric, symmetric, or white box cryptography. The encryption may occur at any of various different levels of the software stack as illustrated in FIG. 4. Once the sensor entries are encrypted, the electronic device 102 may send the encrypted sensor entry 110 directly over to the authentication system 104.

In various embodiments, a portion of the sensor input stream 114 is sent to the authentication system 104 for deciphering. In various embodiments, when the authentication system 104 receives the portion of the sensor input stream 114, the authentication system 104 may decrypt the sensor entries 110 prior to deciphering the passcode entry 116 by the user. A passcode interface configuration 118, which defines the mechanism of interaction with the passcode interface, may be generated by the electronic device 102 and then sent over to the authentication system 104 as well. The passcode interface configuration may specify a mapping between sensor values of the sensor entries and a set of characters used to compose a passcode entry As an example, where the passcode interface is displayed on the touch screen 108, the passcode interface configuration may include geometric definition of the passcode interface on the touch screen 108. In other embodiments, the passcode interface configuration is generated by the authentication system 104. The passcode interface configuration may be generated specifically for a session with a user interacting with the passcode entry interface.

In various embodiments, the portion of the sensor input stream 114 is interpreted to produce a passcode entry 116 by comparing the sensor input stream 114 to a known passcode interface configuration 118. The authentication system 104 can decipher which character or set of characters corresponds to the decrypted sensor entries. The authentication system 104 can then aggregate the deciphered characters or sets of characters in sequence into a passcode entry 116. The passcode entry 116 corresponds to the passcode entered by the user in response to the presentation of the passcode interface.

This technique can be applied, for example, in financial transaction authentication processes. To authenticate a user via a passcode entry, the passcode entry 116 can be compared against an authentic passcode corresponding to an authorized user. For example, the authentic passcode is stored in a financial service system 120. In some embodiments, the financial service system 120 includes the authentication system 104. In some embodiments, the deciphering of the passcode entry 116 is performed by modules on the electronic device 102 instead of by the authentication system 104.

The authorized user and the authentic passcode may be associated with a payment card identity 122. The payment card identity 122 may correspond to a debit card or a credit card. In the illustrated example, the payment card identity 122 is stored on a payment card 124. The payment card identity 122 is extracted via a card reader 126. The card reader 126 is coupled to the electronic device 102, such as via a wired interconnect or wirelessly. The payment card identity 122 and other non-passcode related data are transferred to the electronic device 102. In various embodiments, the payment card identity 122 and other non-passcode related data are encrypted. The payment card identity 122 and other non-passcode related data are then shared with the authentication system 104. Based on the payment identity 120 and the passcode entry 116, the authentication system 104 communicates with the financial service system 120 to confirm the identity and the authorization of the user, such as the payment of the user.

In other embodiments, the authentic passcode is be stored on the payment card 124. For example, an EMV credit card includes an integrated circuit (IC) chip 130 containing the authentic passcode associated with the user of the EMV credit card. Authorization of the user to use the EMV credit card may require a comparison of the passcode entry 116 and the authentic passcode on the IC chip 130 of the EMV credit card. Hence, the authentication system 104 may send the passcode entry 116 to the electronic device 102 once the passcode entry 116 is deciphered. The passcode entry 116 sent back to the electronic device 102 may be encrypted as well. The passcode entry 116 can then be sent to the IC chip 130 for comparison.

While the illustrated embodiment contemplates the sensor entries as touch events on a touch screen and the passcode interface as a key pad displayed on the touch screen, note that the passcode interface does not have to be integral with the sensor device. For example, the sensor may be a vibration sensor, an accelerometer, an optical sensor, a camera, a tactile sensor, or other means of detecting a user's interaction with the passcode interface displayed on a screen of the electronic device.

Also contemplated is a passcode interface that is not solely visual based. In that regard, other examples of types of sensor events where the disclosed technique can apply include voice entry (e.g., input via recognition), gesture entry (e.g., via gesture recognition), vibration entry, eye tracking, or other methods of direct or indirect user input. For example, the passcode interface may be a combination of a visual interface displayed on a screen and an audio interface. The audio interface can include auditory instructions through a speaker and/or auditory input through a microphone. For example, the sensor entry may be a voice entry to a microphone, while the passcode interface is a user interface capable of receiving input through voice entry.

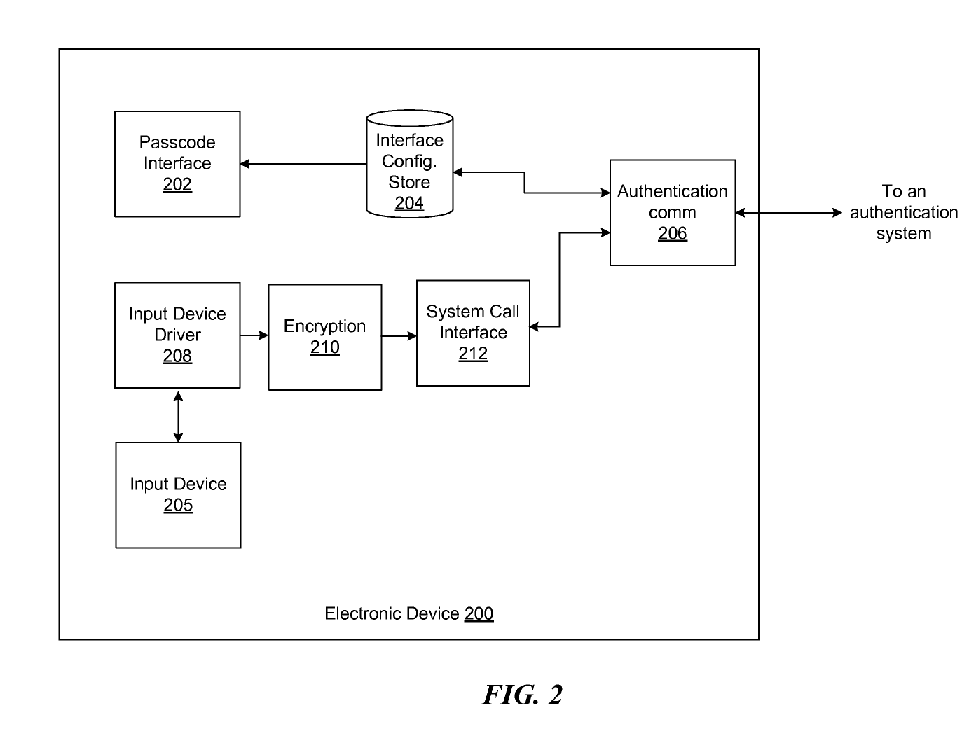

FIG. 2 is a block diagram illustrating an electronic device 200, which may represent device 102 in FIG. 1, for passcode entry. The electronic device 200 may be a general-purpose computing device. The electronic device 200 includes various modules and storage as described below. The electronic device 200 includes a passcode interface module 202, which is configured to present and maintain a passcode interface.

In various embodiments, the passcode interface module 202 is configured to generate the passcode interface. The passcode interface module 202 may generate the passcode interface randomly or pseudo-randomly. As an example, the passcode interface may be configured as a PIN pad layout. The size, arrangement, position, orientation, shape, and other absolute or relative geometric characteristics of the passcode interface and elements within the passcode interface are all examples of the passcode interface configuration. The passcode interface configuration may be selected to promote concealment of a user's entry of a passcode on the passcode interface. For example, the elements on the passcode interface may be characters from which the passcode combination (e.g., the passcode entry 116) may be chosen. The arrangement of the characters and the geometric shapes and sizes of the characters may be randomized. Other attributes of the passcode interface configuration may be wholly or partially randomly generated. The passcode interface configuration, such as the absolute and relative (e.g., relative to a display of the electronic device 200) geometric characteristics of the passcode interface, may be stored in an interface configuration store 204.

In other embodiments, the passcode interface configuration is provided by a remote system through a network, such as the authentication system 104 of FIG. 1. For example, the passcode interface configuration may be received through an authentication communication module 206. In those embodiments, once received, the passcode interface configuration may be stored in the interface configuration store 204. The passcode interface configuration may then be used by the passcode interface module 202 to present the passcode interface to the user.

When the passcode interface configuration is generated on the electronic device 200, the authentication communication module 206 may transmit the passcode interface configuration to the remote system such that the remote system may use a portion of the sensor input stream and the passcode interface configuration to decipher the passcode entry.

The passcode interface module 202 may further be configured to present the passcode interface in a variety of ways. As an example, the presentation of the passcode interface may include displaying or rendering the passcode interface on a touch screen in accordance with the passcode interface configuration, such as a layout configuration. The passcode interface module 202 may render the passcode interface in a two-dimensional or three-dimensional manner. The passcode interface module 202 may also present the passcode interface in other ways, including presenting the passcode interface through animation, audio, webpage, widget, other passive or interactive multimedia, or any combination thereof.

The passcode interface module 202 may be configured to maintain feedback based on an interactivity between the passcode interface and a user. For example, the passcode interface module 202 may be coupled to a touch screen of the electronic device 200, such as the touch screen 108 of FIG. 1. The interactivity enables the passcode interface to provide feedback as a user enters a character or a set of character to be part of the passcode entry.

A record of interactivity is captured with an input device 205, such as the touch screen 108 of FIG. 1. The input device 205 is controlled by an input device driver 208 of the electronic device 200. The input device driver 208 may run on a kernel level of an operating system of the electronic device 200.

In various embodiments, the input device driver 208 captures an input stream from the input device 205. The input device 205 may include any input hardware (i.e., one or more sensors) capable of detecting an sensor entry which implicates (i.e., indicative of) a user's interaction with the passcode interface. The sequence of sensor entries received may constitute the input stream.

The electronic device 200 includes an encryption module 210. The encryption module 210 receives the input stream directly or indirectly from the input device driver 208. For example, the encryption module 210 may access a driver buffer of the input device driver 208 containing the input stream. As another example, the encryption module 210 may respond to an interrupt raised by the input device driver 208 on the kernel level of the operating system. As yet another example, the encryption module 210 may be part of an operating system level library of which interfaces with the drivers on one end and with user-level applications on another.

The encryption module 210 is configured to encrypt sensor entries of the input stream. In some embodiments, the encryption module 210 encrypts each sensor entry separately. In other embodiments, a set of sensor entries are encrypted together. In some embodiments, content values and/or metadata values of each sensor entry are separately encrypted. For example, where the sensor entries are touch events from a touch screen, a location, including X and Y coordinates of each touch screen may be encrypted. As another example, the X and Y coordinates may be encrypted separately.

The authentication communication module 206 is configured to request a sensor input stream from a system call interface module 212 of the electronic device 200. The system call interface module 212 may be part of an operating system kernel of the electronic device 200. The system call interface module 212 may respond to the request by retrieving the sensor input stream from the encryption module 210. In various embodiments, the encryption module 210 may be integral with the system call interface module 212, where the encryption module 210 may encrypt the sensor entries dynamically upon request from the authentication communication module 206 and/or other applications.

In response to receiving the sensor input stream, the authentication communication module 206 sends a portion of the encrypted sensor input stream to an external authentication system, such as the authentication system 104 of FIG. 1, through a network. The portion may be selected from sensor entries recorded while presenting the passcode interface on the electronic device 200.

Although FIG. 2 illustrates the encryption module 210 as encrypting the sensor entries between the input device driver 208 and the system call interface module 212, other embodiments are contemplated in this disclosure as well. For example, the encryption module 210 and the system call interface module 212 may be integrated into a single program. As another example, the encryption module 210 and the input device driver 208 may be integrated into a single program. As yet another example, the encryption module 210 and the authentication communication module 206 may be integrated into a single program.

The interface configuration store 204 described can be implemented in one or more hardware memory components or portions of the hardware memory components. The interface configuration store 204 can be implemented as a dynamic database service or a static data structure. The store can be implemented by a single physical device or distributed through multiple physical devices. The storage space of the store can be allocated at run-time of the modules described above, such as the passcode interface application 202.

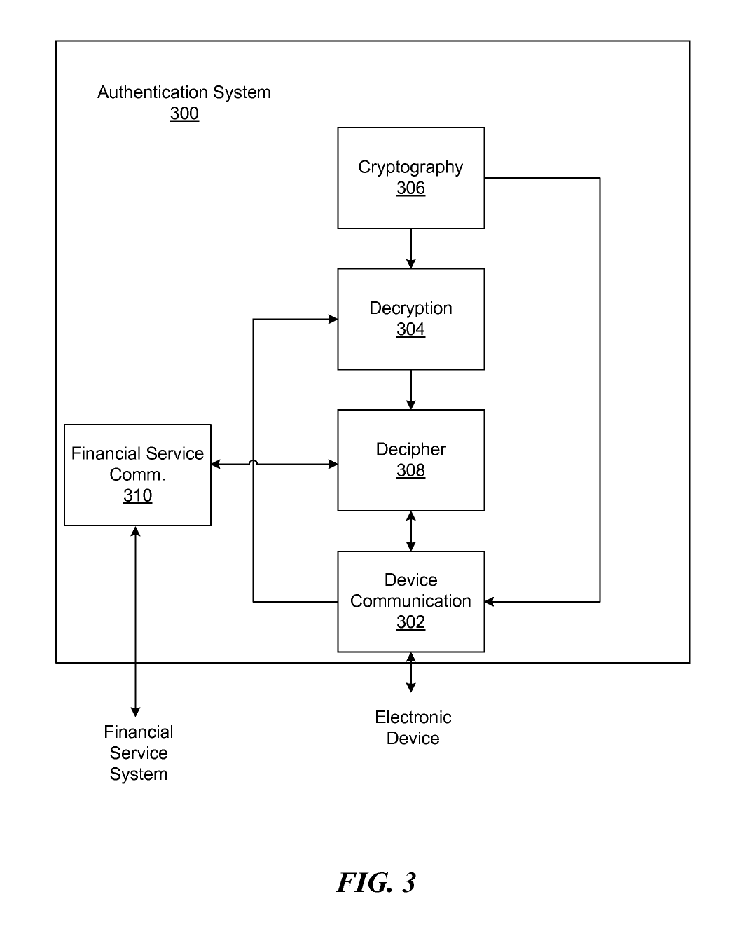

FIG. 3 is a block diagram illustrating an authentication system 300. As shown, the authentication system 300 includes a device communication module 302 configured to communicate with an electronic device, such as the electronic device 200 of FIG. 2. For example, the device communication module 302 may receive a sensor input sequence, such as a touch event sequence, from an electronic device, such as the electronic device 200. In various embodiments, the sensor entries within the sensor input sequence are encrypted.

The authentication system 300 includes a decryption module 304. The decryption module 304 is configured to decrypt the encrypted sensor entries within the sensor input sequence. The decryption methodology in the authentication system 300 may correspond to any encryption methodology implemented on the electronic device, such as in accordance with the cryptography mechanisms described for the encryption module 210. For example, the decryption methodology may be in accordance with asymmetric, symmetric, or white box cryptography.

In some embodiments, the decryption module 304 and/or the cryptography module 306 are implemented as a hardware component. The hardware component may adapted to prevent external access from any external application (e.g., malware application), which otherwise may have gained access to the authentication system 300. This is advantageous to provide an additional layer of security against would-be attackers attempting to discover a user's passcode.

The cryptography key used for decryption can be stored in and retrieved from a cryptography module 306. The cryptography module 306 is configured to manage encryption keys (e.g., public or private key) used for encryption on the electronic device and for decryption on the authentication system 300. In various embodiments, the cryptography module 306 assigns an encryption key to the electronic device by transmitting the encryption key through the device communication module 302.

The authentication system 300 includes a decipher module 308. The decipher module 308 is configured to decipher a passcode entry from a user based on a sensor input sequence. For example, the decipher module 308 may receive the decrypted sensor input sequence from the decryption module 304. In some embodiments, the decipher module 308 also receives a passcode interface configuration from the electronic device through the device communication module 302. In other embodiments, the decipher module 308 accesses a known passcode interface configuration (not shown) that is stored on the authentication system 300.

The decipher module 308 may determine a passcode entry by a user based on the decrypted sensor input sequence and the passcode interface configuration. For example, where the passcode interface is a keypad and the sensor input sequence are touch events, the decipher module 308 may map the touch coordinates of the touch events to known character elements arranged on the keypad. The sequence of interpreted character elements may then be deciphered to be the passcode entry by the user.

The passcode entry may be passed back to the electronic device through the device communication module 302 to be verified, such as to be verified by a card reader attached to the electronic device. The passcode entry may also be passed out to a financial service system to be verified through a financial service communication module 310. The financial service communication module 310 is configured to communicate with an external financial service system, such as the financial service system 120 of FIG. 1.

One or more modules on the electronic device 200 may be implemented on the authentication system 300 and one or more modules of the authentication system 300 may be implemented on the electronic device 200. For example, the cryptography module 306 of the authentication system 300 may be implemented on the electronic device 200, where the encryption key and decryption key are distributed from the electronic device 200 to the authentication system 300.

FIG. 4 is a system architecture diagram of an electronic device 400, such as the electronic device 102 or the electronic device 200, illustrating a data path through which a sensor entry may be processed. The electronic device 400 includes a sensor device 402 that can record a sequence or a stream of sensor entries, such as coordinates of a detected touch on a touch screen (“touch events”), at a hardware level 404. The hardware level 404 includes at least a physical hardware component of the electronic device 400 that is either coupled to the electronic device 400 or integral to the electronic device. The sensor device 402 may be a touch screen, for example. The sensor device 402 may include a sensor controller 406. The sensor controller 406, for example, can be a specialized integrated circuit for controlling one or more sensors within the sensor device 402. The sensor controller 406, for example, can be a field programmable gate array (FPGA), a programmable microcontroller, or an application specific IC (ASIC). The sensor controller 406 may execute a sensor firmware 408. Operations of the sensor firmware 408 may be considered to be within a firmware level 410 of the system architecture.

The sensor firmware 408 or the sensor controller 406 may transmit the sensor entry to a sensor device driver 412 at a kernel level 414 of the system architecture. The sensor device driver 412 may be coupled to a driver buffer 416, which is a memory space to store incoming sensor inputs. The sensor entry received by the sensor device driver 412 may be stored in the driver buffer 416. The sensor device driver 412 is a computer program that operates or controls the sensor device 402 on behalf of an operating system 418 of the electronic device 400. The sensor device driver 412 may communicate with the sensor controller 406 or the sensor firmware 408 through a bus or other wired or wireless communication system.

As shown in FIG. 4, the operating system 418 running on the electronic device 400 includes a kernel program 420. The kernel program 420 is a computing program that manages input/output requests from software running on the electronic device 400, and translates the requests into data processing instructions for a central processing unit (CPU) and/or other electronic components of the electronic device 400. For example, the kernel program 420 may serve as a system call interface service to a passcode authentication application 422 running on a user level 424 of the operating system 418. The kernel program 420 enables certain programs including device drivers (e.g., the sensor device driver 412) to run on the kernel level 414 with different privileges and/or constraints compared an application on the user level 424. Modules running on the kernel level 414 may have higher execution privileges, have separate address spaces, have parallel execution threads (e.g., instead of sequential execution), have the capability of interrupt based processes, can shared data with each other, can be pre-emptible, or any combination thereof.

The passcode authentication application 422, such as the authentication communication module 206 of FIG. 2, may communicate with the sensor device driver 412 through the kernel program 420. For example, the passcode authentication application 422 may access the sensor entries in the sensor input stream provided by the sensor device 402.

Encryption of the sensor entries in the sensor input stream may occur at the firmware level 410, the kernel level 414, the user level 424, or a combination thereof. The encrypted sensor entries are advantageous in protecting against malware running either on the kernel level 414 or the user level 424. In various embodiments, while an encryption key is provided on the electronic device, a decryption key is not known to the electronic device. In other embodiments, a symmetric key is used for both encryption and decryption. In those cases, the symmetric key and the encryption algorithm are mathematically composed as a data object (e.g., a block of code or a compiled binary) from which an attacker cannot determine the original symmetric key without significant effort.

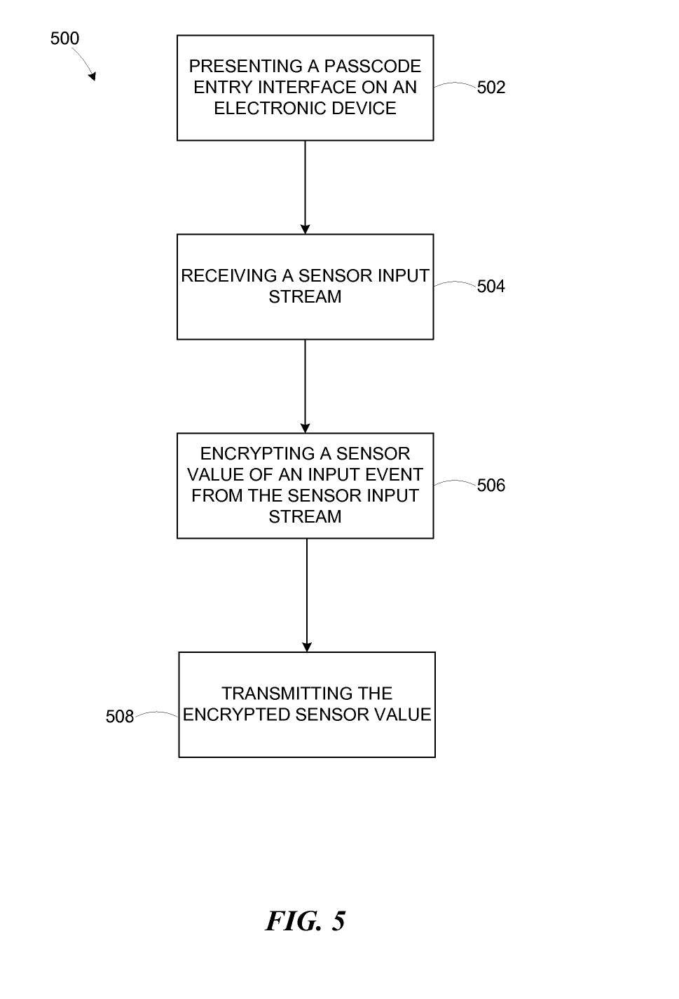

FIG. 5 illustrates a flow chart of a process 500 of operating an electronic device (e.g., the electronic device 102, the electronic device 200 or the electronic device 400) to encrypt a sensor value implicating a user input to a passcode entry interface. The electronic device presents a passcode code interface on a display, such as a touch screen, for a user to input a passcode entry at a step 502. For example, the passcode entry interface presented may be a keypad for authenticating a user for payment to/from a financial service system. Step 502 may be performed by the passcode entry interface module 202. The passcode entry interface may be presented in response to initiation of a financial transaction on the electronic device, such as when a card reader, coupled to the electronic device, detects a swipe of a payment card by a user.

A sensor input stream from a sensor of the electronic device is received at step 504. The sensor entries from the sensor input stream may be represent or be indicative of a user's interaction with the passcode entry interface. For example, the sensor input stream can be a touch event stream from a touch screen of the electronic device. Each touch event may include a coordinate of where a touch has been detected by the touch screen. Step 504 may be performed by the input device driver 208.

Next, the electronic system encrypts a sensor value of an input event from the sensor input stream at step 506. The sensor value may be encrypted along with metadata of the input event entry. Where multiple sensor values are collected in a single input event entry (e.g., x-coordinate and a y-coordinate of a touch event), the multiple sensor values may be encrypted together. In some implementations, multiple sensor entries may be encrypted in batch, such as multiple touch locations (e.g., multiple sets of x-coordinate and y-coordinate). Step 506 may be performed by the encryption module 210 and may be performed on a kernel level of the electronic device.

The electronic device can then transmit the encrypted sensor value to an external system over a network at step 508. The encrypted sensor value may be transmitted as a command, a request, or any other type of message or signal that causes the external system to decipher the passcode from the encrypted sensor value. The external system may be the authentication system 300 of FIG. 3 for deciphering the passcode from the encrypted sensor value and authenticating the user based on the passcode. Step 508 may be performed by the authentication communication module 206.

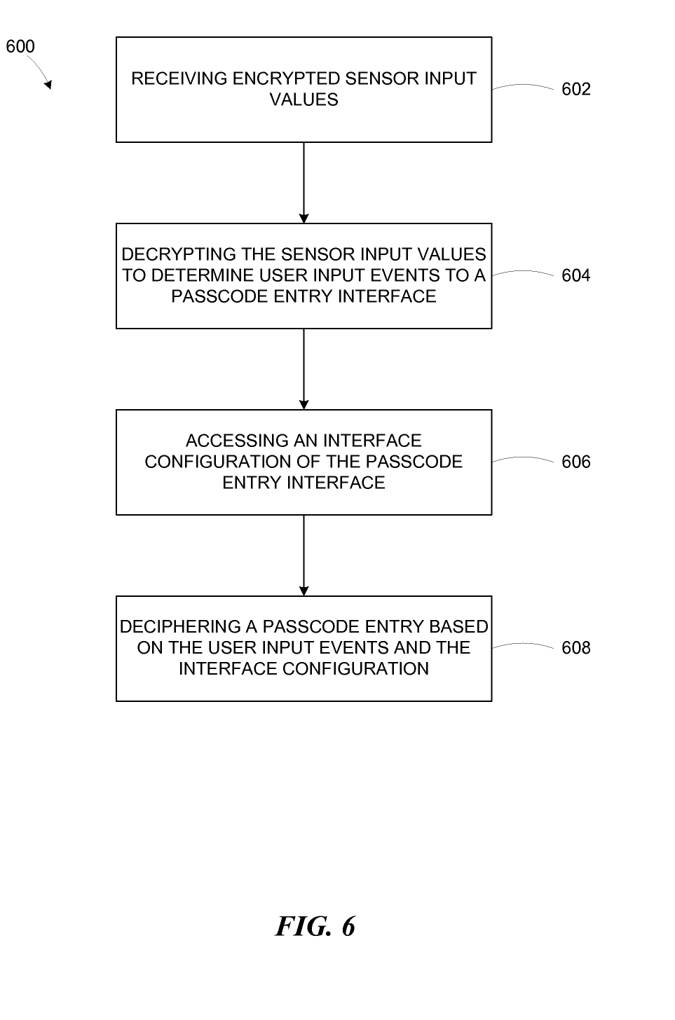

FIG. 6 illustrates a flow chart of a process 600 of operating a computing system (e.g., the authentication system 300 of FIG. 3) for deciphering a passcode by a user. The computing system receives encrypted sensor input values from an electronic device, such as the electronic device 102, the electronic device 200 or the electronic device 400, at step 602. In various embodiments, the sensor input values correspond to user interactions with a passcode entry interface presented on the electronic device. The encrypted sensor input values may correspond to a period when the passcode entry interface is presented on the electronic device. Step 602 may be performed by the device communication module 302 of FIG. 3.

Next, the computing system decrypts sensor values from the encrypted sensor input values at step 604. The decrypted sensor values may be used to determine user input events with the passcode entry interface. Step 604 may be performed by the decryption module 304 of FIG. 3.

Once decrypted, the computing system accesses an interface configuration of the passcode entry interface at step 606. The interface configuration may specify a mapping between the sensor input values and the set of characters used to compose a passcode entry, such as the characters composing the passcode entry corresponding to the sensor input values. The interface configuration may be generated on the computing system or on the electronic device. The interface configuration may be generated specifically for a session with the user interacting with the passcode entry interface.

Based on the interface configuration and the decrypted sensor input values of the user input events, the computing system deciphers the passcode entry entered by the user at step 608. Step 606 and step 608 may be performed by the decipher module 306 of FIG. 3.

Regarding the process 500 and the process 600, while the various steps, blocks or sub-processes are presented in a particular order, alternative embodiments may perform routines having steps, or employ systems having steps, blocks or sub-processes, in a different order, and some steps, sub-processes or blocks may be deleted, moved, added, subdivided, combined, and/or modified to provide alternative or subcombinations. Each of these steps, blocks or sub-processes may be implemented in a variety of different ways. Also, while steps, sub-processes or blocks are at times shown as being performed in series, some steps, sub-processes or blocks may instead be performed in parallel, or may be performed at different times as will be recognized by a person of ordinary skill in the art. Further any specific numbers noted herein are only examples.

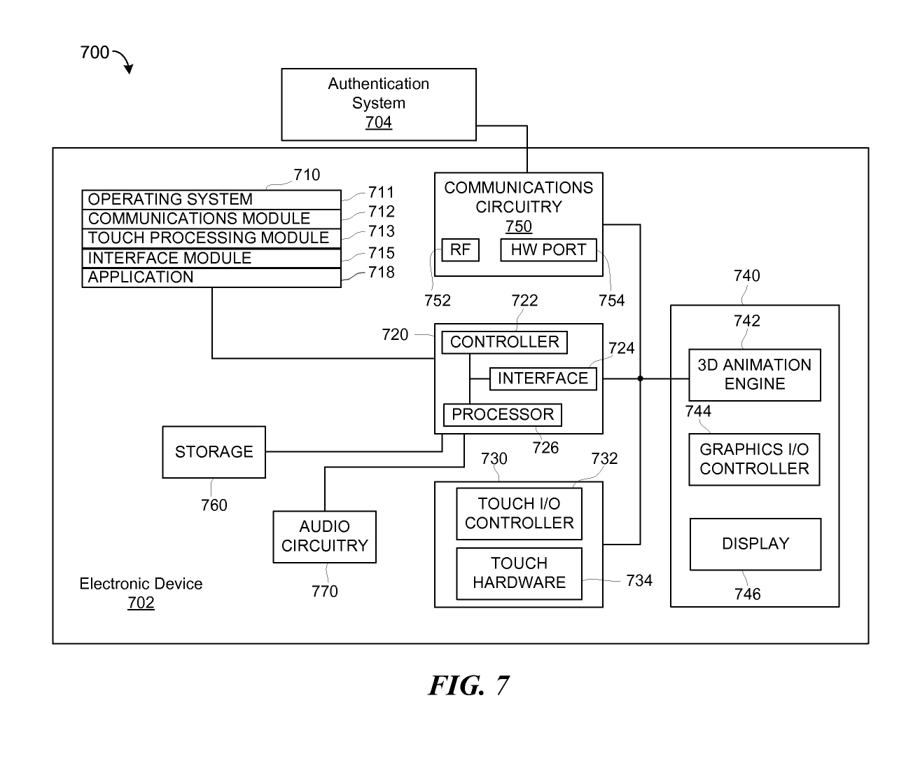

FIG. 7 is a block diagram of a passcode entry system 700 including an electronic device 702 (e.g., the electronic device 200 of FIG. 2) and an authentication system 704 (e.g., the authentication system 300 of FIG. 3). Note that the architecture shown in FIG. 7 is only one example architecture of the passcode entry system 700, and that the electronic device 702 could have more or fewer components than shown, or a different configuration of components. The various components shown in FIG. 7 can be implemented by using hardware, software, firmware or a combination thereof, including one or more signal processing and/or application specific integrated circuits.

The electronic device 702 that can include one or more computer-readable mediums 710, processing system 720, touch subsystem 730, display/graphics subsystem 740, communications circuitry 750, storage 760, and audio circuitry 770. These components may be coupled by one or more communication buses or other signal lines. The electronic device 702 can be the same as or similar to the electronic device 102, the electronic device 200, or the electronic device 400.

The communications circuitry 750 can include RF circuitry 752 and/or port 754 for sending and receiving information. The RF circuitry 752 permits transmission of information over a wireless link or network to one or more other devices and includes well-known circuitry for performing this function. The port 754 permits transmission of information over a wired link. The communications circuitry 750 can communicate, for example, with the authentication system 704. The communications circuitry 750 can be coupled to the processing system 720 via a peripherals interface 724. The peripherals interface 724 can include various known components for establishing and maintaining communication between peripherals and the processing system 720.

The audio circuitry 770 can be coupled to an audio speaker (not shown), a microphone (not shown), an electronic card reader (not shown), or any combination thereof and includes known circuitry for processing voice signals received from the peripherals interface 724 to enable a user to communicate in real-time with other users. In some embodiments, the audio circuitry 770 includes a headphone jack (not shown).

The peripherals interface 724 can couple various peripherals, such as an electronic card reader, of the system to one or more processors 726 and the computer-readable medium 710. The one or more processors 726 can communicate with one or more computer-readable mediums 710 via a controller 722. The computer-readable medium 710 can be any device or medium that can store code and/or data for use by the one or more processors 726. The medium 710 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). The medium 710 may also include a transmission medium for carrying information-bearing signals indicative of computer instructions or data (with or without a carrier wave upon which the signals are modulated). For example, the transmission medium may include a communications network, including but not limited to the Internet, intranet(s), Local Area Networks (LANs), Wide Local Area Networks (WLANs), Storage Area Networks (SANs), Metropolitan Area Networks (MAN) and the like.

The one or more processors 726 can run various software components stored in the medium 710 to perform various functions for the electronic device 702. Note that the order of the modules in the medium 710 does not denote the order of a software stack as implemented in the medium 710. In some embodiments, the software components include an operating system 711, a communication module (or set of instructions) 712, a touch processing module (or set of instructions) 713, an interface module (or set of instructions) 715, such as the passcode interface module 202 of FIG. 2, and one or more applications (or set of instructions) 718. Each of these modules and above noted applications correspond to a set of instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules may be combined or otherwise rearranged in various embodiments. In some embodiments, the medium 710 may store a subset of the modules and data structures identified above. Furthermore, the medium 710 may store additional modules and data structures not described above.

The operating system 711 can include various procedures, sets of instructions, software components and/or drivers for controlling and managing general system tasks (e.g., memory management, storage device control, power management, etc.) and facilitates communication between various hardware and software components.

The communication module 712 facilitates communication with other devices using the communications circuitry 750 and includes various software components for handling data received from the RF circuitry 752 and/or the port 754.

The touch processing module 713 includes various software components for performing various tasks associated with touch hardware 734 including but not limited to receiving and processing touch input received from the I/O device 730 via a touch I/O device controller 732. For example, the touch processing module 713 can also include software components for performing tasks associated with other I/O devices (not shown).

The interface module 715 is configured to present and maintain a passcode interface for a user to enter a passcode to authenticate the user's identity. The interface module 715 can include various known software components for rendering, animating and displaying graphical objects on a display surface. In embodiments, in which the touch hardware 734 is a touch sensitive display (e.g., touch screen), the interface module 715 includes components for rendering, displaying, and animating objects on the touch sensitive display. The interface module 715 can provide animation instructions to an animation engine 722, which can render the graphics and provide the rendering to graphics I/O controller 744, so that the graphics I/O controller 744 can display the graphics on display 746. The interface module 715 can further control the audio circuitry 770 to provide an auditory component to the passcode interface.

One or more applications 718 can include any applications installed on the electronic device 702, including without limitation, modules of the electronic device 200, a browser, keyboard emulation, widgets, JAVA-enabled applications, encryption, digital rights management, voice recognition, voice replication, location determination capability (such as that provided by the global positioning system (GPS)), etc.

The touch I/O controller 732 is coupled to the touch hardware 734 for controlling or performing various functions. The touch hardware 732 communicates with the processing system 720 via the touch I/O device controller 732, which includes various components for processing user touch input (e.g., scanning hardware). One or more other input controllers (not shown) receives/sends electrical signals from/to other I/O devices (not shown). Other I/O devices may include physical buttons, dials, slider switches, sticks, keyboards, touch pads, additional display screens, or any combination thereof.

If embodied as a touch screen, the touch hardware 734 displays visual output to the user in a GUI. The visual output may include text, graphics, video, and any combination thereof. Some or all of the visual output may correspond to user-interface objects. The touch hardware 734 forms a touch-sensitive surface that accepts touch input from the user. The touch hardware 734 and the touch controller 732 (along with any associated modules and/or sets of instructions in the medium 710) detects and tracks touches or near touches (and any movement or release of the touch) on the touch hardware 734 and converts the detected touch input into interaction with graphical objects, such as one or more user-interface objects. In the case in which the touch hardware 734 and the display 746 are embodied as a touch screen, the user can directly interact with graphical objects that are displayed on the touch screen. Alternatively, in the case in which hardware 734 is embodied as a touch device other than a touch screen (e.g., a touch pad), the user may indirectly interact with graphical objects that are displayed on a separate display screen.

Embodiments in which the touch hardware 734 is a touch screen, the touch screen may use LCD (liquid crystal display) technology, LPD (light emitting polymer display) technology, OLED (organic light emitting diode), or OEL (organic electro luminescence), although other display technologies may be used in other embodiments.

Feedback may be provided by the touch hardware 734 based on the user's touch input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

In some embodiments, the peripherals interface 724, the one or more processors 726, and the memory controller 722 may be implemented on a single chip. In some other embodiments, they may be implemented on separate chips. The storage 760 can be any suitable medium for storing data, including, for example, volatile memory (e.g., cache, RAM), non-volatile memory (e.g., Flash, hard-disk drive), or a both for storing data, including pages used for transition animations.

Regarding FIGS. 2-4 and 7, blocks, components, and/or modules associated with the electronic device 200, the authentication system 300, or the electronic device 702 each may be implemented in the form of special-purpose circuitry, or in the form of one or more appropriately programmed programmable processors, or a combination thereof. For example, the modules described can be implemented as instructions on a tangible storage memory capable of being executed by a processor or a controller on a machine. The tangible storage memory may be a volatile or a non-volatile memory. In some embodiments, the volatile memory may be considered “non-transitory” in the sense that it is not a transitory signal. Modules may be operable when executed by a processor or other computing device, e.g., a single board chip, application specific integrated circuit, a field programmable field array, a network capable computing device, a virtual machine terminal device, a cloud-based computing terminal device, or any combination thereof.

Each of the modules may operate individually and independently of other modules. Some or all of the modules may be executed on the same host device or on separate devices. The separate devices can be coupled via a communication module to coordinate its operations via an interconnect or wireless sly. Some or all of the modules may be combined as one module.

A single module may also be divided into sub-modules, each sub-module performing separate method step or method steps of the single module. In some embodiments, the modules can share access to a memory space. One module may access data accessed by or transformed by another module. The modules may be considered “coupled” to one another if they share a physical connection or a virtual connection, directly or indirectly, allowing data accessed or modified from one module to be accessed in another module. In some embodiments, some or all of the modules can be upgraded or modified remotely. The electronic device 200, the authentication system 300, or the electronic device 702 may include additional, fewer, or different modules for various applications.

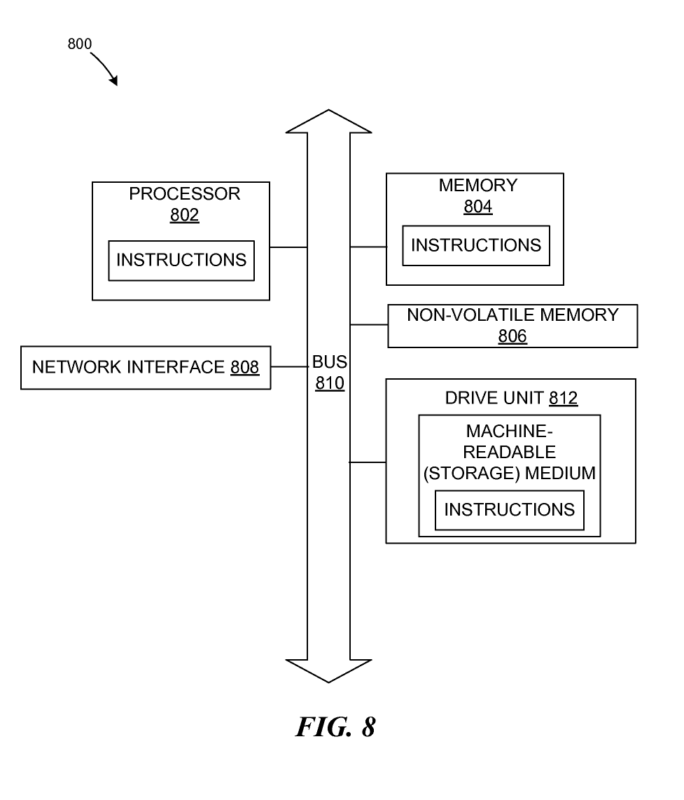

FIG. 8 is a diagrammatic representation of a computer system 800. The computer system 800 is intended to illustrate a hardware device on which any of the modules and components depicted in the example of FIG. 3 (and any other modules and/or components described in this specification) can be implemented. As shown, the computer system 800 includes a processor 802, memory 804, non-volatile memory 806, and a network interface 808. Various common components (e.g., cache memory) are omitted for illustrative simplicity. The computer system 800 can be of any applicable known or convenient type, such as a personal computer (PC), server-class computer or mobile device (e.g., smartphone, card reader, tablet computer, etc.). The components of the computer system 800 can be coupled together via a bus and/or through any other known or convenient form of interconnect.

One of ordinary skill in the relevant art will recognize that the terms “machine-readable (storage) medium” or “computer-readable (storage) medium” include any type of device that is accessible by the processor 802. The memory 804 is coupled to the processor 802 by, for example, a bus 810. The memory 804 can include, by way of example but not limitation, random access memory (RAM), such as dynamic RAM (DRAM) and static RAM (SRAM). The memory 804 can be local, remote, or distributed.

The bus 810 also couples the processor 802 to the non-volatile memory 806 and drive unit 812. The non-volatile memory 806 may be a hard disk, a magnetic-optical disk, an optical disk, a read-only memory (ROM), such as a CD-ROM, Erasable Programmable Read-Only Memory (EPROM), or Electrically Erasable Programmable Read-Only Memory (EEPROM), a magnetic or optical card, or another form of storage for large amounts of data. The non-volatile storage 806 can be local, remote, or distributed.

The modules described in FIG. 3 may be stored in the non-volatile memory 806, the drive unit 812, or the memory 804. The processor 802 may execute one or more of the modules stored in the memory components.

The bus 810 also couples the processor 802 to the network interface device 808. The interface 808 can include one or more of a modem or network interface. A modem or network interface can be considered to be part of the computer system 800. The interface 808 can include an analog modem, ISDN modem, cable modem, token ring interface, satellite transmission interface (e.g. “direct PC”), or other interfaces for coupling a computer system to other computer systems.

Each section or figure of this disclosure may exemplify different implementations and relationships between elements and terms. However, similar elements and terms referred in the different sections of this disclosure and the drawings are meant to be compatible with each other in various embodiments.

Alternative language and synonyms may be used for any one or more of the terms discussed herein, nor is any special significance to be placed upon whether or not a term is elaborated or discussed herein. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Those of skill in the art will appreciate that the invention may be embodied in other forms and manners not shown below. It is understood that the use of relational terms, if any, such as first or second, and the like are used solely for distinguishing one entity or action from another, without necessarily requiring or implying any such actual relationship or order between such entities or actions.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list. The word “portion” or “portioned” in reference to a sequence includes any subset or the whole of the sequence.

Reference in this specification to “various embodiments” or “some embodiments” means that a particular feature, structure, or characteristic described in connection with the embodiment is included in at least one embodiment of the disclosure. An embodiment and an alternative embodiment (e.g., referenced as “other embodiments”) made in reference thereto may not be mutually exclusive of each other. Moreover, various features are described which may be exhibited by some embodiments and not by others. Similarly, various requirements are described which may be requirements for some embodiments but not other embodiments.

The above description and drawings are illustrative and are not to be construed as limiting the invention to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and such references mean at least one of the embodiments.

What is claimed is:

1. A method of operating a mobile device to prevent an unauthorized capture of a passcode entry in a financial transaction, the method comprising:
initiating the financial transaction when a card reader, coupled to the mobile device, detects swiping of a payment card from a user;
presenting a passcode entry interface on a touch screen of the mobile device for the user to input a passcode;
during the presenting of the passcode entry interface, receiving a touch event from the touch screen;
encrypting a location of the touch event, indicative of where a touch by the user occurred on the touch screen; and
transmitting the encrypted location to an external system over a network, to cause the external system to authenticate the user by deciphering the passcode based at least in part on the encrypted location of the touch event.

2. The method of claim 1, further comprising encrypting a metadata entry of the touch event together with the location of the touch event.

3. The method of claim 1, wherein encrypting the location of the touch event comprises using asymmetric cryptography.

4. The method of claim 1, wherein encrypting the location of the touch event is performed in batch with encrypting a location of another touch event.

5. The method of claim 1, further comprising transmitting data indicating a screen geometry of the touch screen to the external system.

6. A method of operating an electronic device to prevent an unauthorized capture of a passcode in a financial transaction, the method comprising:
presenting a passcode entry interface on the electronic device for a user to input a passcode entry;
receiving an input event from a sensor of the electronic device, wherein the input event is indicative of at least part of the passcode entry by the user and includes at least a sensor value as measured by the sensor;
encrypting the sensor value of the input event; and
transmitting the encrypted sensor value to an external system over a network to cause the external system to decipher the passcode entry based at least in part on the encrypted sensor value.

7. The method of claim 6, further comprising transmitting an interface configuration of the passcode entry interface to the external system, wherein the interface configuration specifies a mapping between sensor values from the sensor and a set of characters for composing the passcode entry.

8. The method of claim 7, wherein the interface configuration includes a geometric characteristic of the passcode entry interface as presented on a touch screen of the electronic device.

9. The method of claim 7, further comprising encrypting the interface configuration prior to transmitting the interface configuration.

10. The method of claim 7, further comprising generating a randomized arrangement for the passcode entry interface; wherein the randomized arrangement is recorded as part of the interface configuration.

11. The method of claim 6, further comprising transmitting a screen geometry of a display device of the electronic device to the external system, wherein the passcode entry interface is displayed on the display device.

12. The method of claim 6, wherein encrypting the sensor value of the input event comprises using white box cryptography.

13. The method of claim 6, wherein encrypting the sensor value of the input event comprises using asymmetric cryptography.

14. A method of operating a computing system for deciphering a passcode based at least in part on sensor inputs, the method comprising:
receiving an encrypted sensor input value from an electronic device, wherein the encrypted sensor input value corresponds to a user interaction with a passcode entry interface on the electronic device;
decrypting the encrypted sensor input value to determine a user input event;
accessing an interface configuration of the passcode entry interface that specifies a mapping between sensor input values and a set of characters for composing the passcode; and
deciphering a passcode entry by a user based at least in part on the user input event and the interface configuration.

15. The method of claim 14, further comprising generating the interface configuration specifically for a session with a user interacting with the passcode entry interface.

16. The method of claim 15, wherein generating the interface configuration includes generating the interface configuration as a randomized arrangement of interactive buttons; and wherein accessing the interface configuration includes accessing locations of the interactive buttons.

17. The method of claim 16, further comprising transmitting the interface configuration to the electronic device to enable a display of the passcode entry interface on the electronic device.

18. The method of claim 14, wherein accessing the interface configuration includes receiving an encrypted configuration from the electronic device and decrypting the encrypted configuration as the interface configuration.

19. A computer program product encoded on a computer storage medium, operable when executed by a processor, wherein the computer program product is operable to:
present a passcode entry interface on an electronic device for a user to input a passcode entry;
receive an input event from a sensor of the electronic device, wherein the input event is indicative of at least part of the passcode entry by the user and includes at least a sensor value as measured by the sensor;
encrypt the sensor value of the input event; and
transmit the encrypted sensor value to an external system over a network to cause the external system to decipher the passcode entry based at least in part on the encrypted sensor value.

20. An electronic device comprising:
a memory;
a display device to present a passcode entry interface for a user to input a passcode entry;
a sensor to store a sensor input sequence in the memory, wherein the sensor input sequence is indicative of a user interaction with the passcode entry interface; and
a processor to encrypt a sensor entry of the sensor input sequence and to transmit the encrypted sensor entry to a remote system over a network to decipher the passcode entry by the user.

21. A computer server system comprising:
a network interface through which to receive a sensor input sequence from an electronic device, wherein the sensor input sequence is indicative of a user interaction with a passcode entry interface on the electronic device;
a security component to decrypt an encrypted sensor entry of the sensor input sequence; and
a processor configured to decipher a passcode entry by the user based on at least the decrypted sensor entry and data indicative of a geometry of the passcode entry interface.
